(19) United States
(12) Patent Application Publication
(10) Pub. No.: US 2015/0128190 A1
(43) Pub. Date: May 7, 2015

(54) Video Program Recommendation Method and Server Thereof

(71) Applicant: NTT DoCoMo, Inc., Tokyo (JP)

(72) Inventors: Yingjie WANG, Beijing (CN); Yongsheng ZHANG, Beijing (CN); Hidetoshi KAYAMA, Beijing (CN)

(73) Assignee: NTT DoCoMo, Inc., Tokyo (JP)

(21) Appl. No.: 14/515,784

(22) Filed: Oct. 16, 2014

(30) Foreign Application Priority Data
Nov. 6, 2013 (CN) 201310545915.6

(51) Int. Cl. H04N 21/235; H04N 21/25; H04N 21/482; G06F 17/30; H04N 21/61

(52) U.S. Cl. CPC H04N 21/2353; G06F 17/30828; H04N 21/6125; H04N 21/4826; H04N 21/251
USPC 725/53

(57) ABSTRACT

Disclosed is a method and server for generating a video program recommendation for a particular video program. The method may include the following steps of: extracting key information from an electronic program guide of a particular video program and the particular video program; searching for contents related with the key information on a public social media by using the key information, and obtaining search results; extracting an abstract from the search results as an inquiry request; searching for video programs in a broadcasting video library and an Internet video library based on the inquiry request, and using obtained search results as a video program recommendation for the particular video program; and storing the video program recommendation in association with the particular video program. By using the solutions of the above embodiments, video program recommendations may be generated collectively for video programs at the side of the server.

### CROSS-REFERENCE TO RELATED APPLICATION

The present application claims a priority of the Chinese patent application No. 201310545915.6 filed in China on Nov. 6, 2013, which is incorporated herein by reference in its entirety.

### TECHNICAL FIELD

The present disclosure relates to mobile video technology, and in particular, to a video program recommendation method and a server thereof.

### BACKGROUND

With the development of Internet technology and communication technology, Mobile Internet and Multimedia Broadcast have been widely applied in various aspects of daily life. A mobile multimedia broadcasting network may be standardized wireless broadcasting network systems, such as CMMB (China Mobile Multimedia Broadcast), ISTB-Tmm (Integrated Services Digital Broadcasting-Terrestrial mobile multimedia), etc. People receive multimedia broadcasts such as television and radio station programs through special CMMB receiving terminals or mobile phones provided with CMMB modules.

In this case, a mobile multimedia terminal can not only receive traditional television broadcasting programs, but also play streaming video programs on Internet by accessing the Internet. For example, a smart mobile phone or a tablet PC provided with a CMMB module accesses Internet via WiFi or a wireless wide area network to achieve access to videos on the Internet. However, the massive video information on the Internet makes it difficult for a user to determine videos that he/she wants to watch. Generally, a user searches for desired video programs or preferred programs by searching for key words. How to generate a corresponding video program recommendation for each video program is a technical problem in the mobile internet age.

### SUMMARY

In view of one or more problems in the prior art, the present disclosure proposes a video program recommendation method and a server thereof.

According to an aspect of the present disclosure, a method for generating a video program recommendation for a particular video program is proposed, the method including the following steps of: extracting key information from an electronic program guide of a particular video program and the particular video program; searching for contents related with the key information on a public social media by using the key information, and obtaining search results; extracting an abstract from the search results as an inquiry request; searching for video programs in a broadcasting video library and an internet video library based on the inquiry request, and using obtained search results as a video program recommendation for the particular video program; and storing the video program recommendation in association with the particular video program.

Preferably, the method may further include a step of: sending the video program recommendation to a user when the user requests for the particular video program.

Preferably, the step of extracting key information from an electronic program guide of a particular video program and the particular video program may include: parsing the electronic program guide to extract key words; extracting key frames from the particular video program; recognizing the extracted key frames to obtain recognized text contents; and combining at least part of the recognized text contents and the key words, using the combined as the key information.

Preferably, the step of extracting key frames from the particular video program may include: extracting image frames representative of main contents of video shots from the particular video program as the key frames.

Preferably, the step of recognizing the extracted key frames may include: recognizing text contents in the extracted key frames by using text recognition technology.

Preferably, the step of combining at least part of the recognized text contents and the key words may include: weighting at least part of the recognized text contents and the key words followed by sequencing them to generate the key information.

Preferably, the step of extracting an abstract from the search results may include: scoring each of the search results; and extracting key words from search results whose scores are higher than a predetermined value to generate the abstract.

Preferably, the step of searching for contents related with the key information on a public social media by using the key information may include: crawling contents on the public social media to generate public social media indices; matching the key information with the public social media indices; and taking contents corresponding to the public social media indices whose matching degrees are higher than a predetermine threshold as the search results.

Preferably, the step of searching for video programs in a broadcasting video library and an internet video library based on the inquiry request may include: crawling the broadcasting video library and internet video library to generate streaming video program indices; matching the inquiry request with the streaming video program indices; and taking contents corresponding to the streaming video program indices whose matching degrees are higher than a predetermine threshold as the search results.

According to another aspect of the present invention, a server for generating a video program recommendation for a particular video program is proposed, the server comprising: an extractor for extracting key information from an electronic program guide of a particular video program and the particular video program; a search engine for searching for contents related with the key information on a public social media by using the key information, obtaining search results, extracting an abstract from the search results as an inquiry request, and searching for video programs in a broadcasting video library and an internet video library based on the inquiry request, and using obtained search results as a video program recommendation for the particular video program; and a storage for storing the video program recommendation in association with the particular video program.

By using the solutions of the above embodiments, video program recommendations can be generated collectively for video programs at the side of the server.

### DESCRIPTION OF THE DRAWINGS

FIG. 1 illustrates the structure of a video program recommendation system according to an embodiment of the present disclosure;

FIG. 2 illustrates the structures of a mobile Internet terminal and a server in a video program recommendation system according to another embodiment of the present disclosure;

FIG. 3 illustrates an interaction process of a mobile Internet terminal and a server according to an embodiment of the present disclosure; and

FIG. 4 is a flow chart of a recommendation method according to an embodiment of the present disclosure.

### DETAILED EMBODIMENTS

Preferred embodiments disclosed in the present disclosure will be described in detail hereinafter with reference to the accompanying drawings. Although shown in different drawings, the same reference sign is used to indicate the same or similar component. For clarity and simplicity, detailed description for known functions and structures included herein will be omitted to avoid unclearness of the subject of each embodiment of the present disclosure.

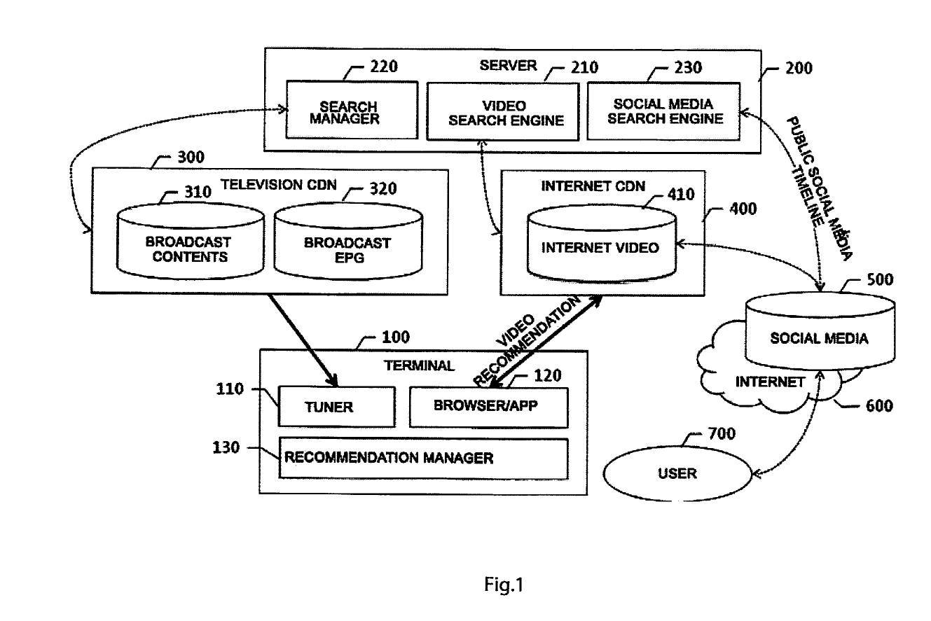

FIG. 1 is a schematic diagram of a video program recommendation system according to an embodiment of the present disclosure. According to one or more embodiments of the present disclosure, a terminal 100 is a smart mobile phone having a mobile television module, and thus can not only receive broadcasting and television programs, but also access video programs on the Internet 600, such as YouTube, etc, and social media 500, via for example WiFi or a wireless wide area network. For example, a user obtains a traditional broadcasting program through a tuner 110 in the terminal 100, and plays a video program on the Internet through a browser/APP 120. In addition, the terminal shown in FIG. 1 further includes a recommendation manager 130, which stores social information of a user such as a social media account number of Twitter or Weibo, information such as watch history and operation database and the like, and also manages recommendation events.

As shown in FIG. 1, a server 200 includes a search manager 220, a video search engine 210 and a social media search engine 230. In some embodiments, the video search engine 210 and social media search engine 230 may be formed into one module, which is called as a search engine. In the embodiments as shown in the figures, before a CDN 300 video program is played on the mobile multimedia terminal 100, the search engine in the server 200 may generate a video recommendation for the programs to be played based on information of a public social media and Internet video program 410, which reduces the workload of the mobile terminal. For example, key information is extracted from the electronic program guide of the video program and the video program, and social media information associated with the program is crawled from a public social media 500, so as to generate video program indices. Thereafter, the key information is used as a search query to conduct matching in the social media indices to generate search results. And then, an abstract is generated from the search results as a new search query, and matching search is further performed in the streaming media indices previously generated by the server 200 by crawling the program 410 in the Internet video library 400, so as to obtain video program recommendation search results, which are stored in association with the video programs, or are further transmitted to the terminal 100 to be presented to the user by the recommendation manager 130 of the terminal.

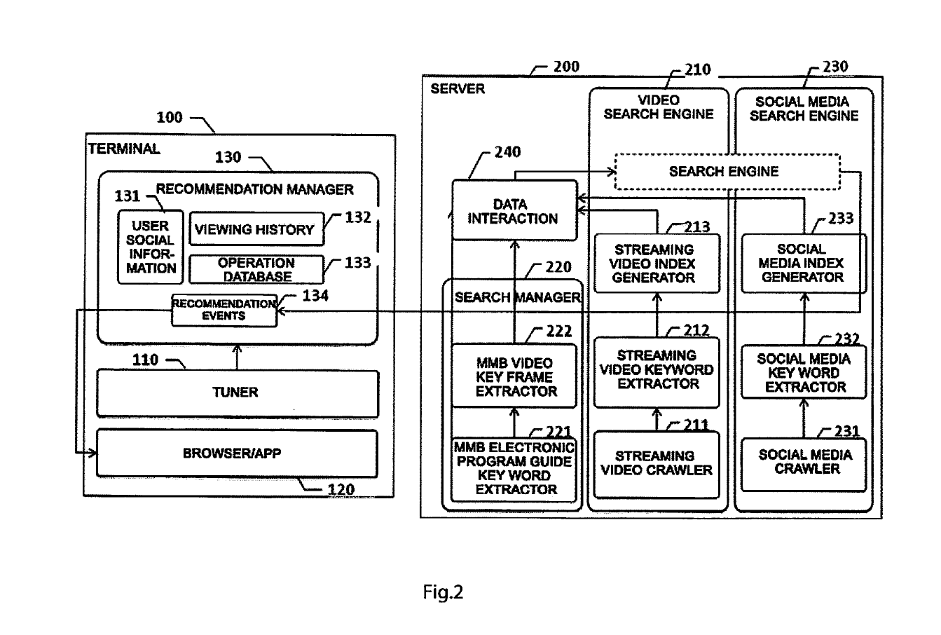

FIG. 2 illustrates the structures of a mobile Internet terminal and a server in a video program recommendation system according to another embodiment of the present disclosure. The system as shown in FIG. 2 includes a terminal 100 and a server 200. The terminal 100 includes a tuner 100, a browser/APP 120 and a recommendation manager 130. In the embodiments shown in the figures, the recommendation manager 130 manages social media information 131 of a user, watch history 132, an operation database 133 and recommendation events 134. In the embodiments shown in the figures, the server 200 includes a search manager 220, a video search engine 210, a social media search engine 230 and a data interaction unit 240. The search manager includes a broadcasting electronic program guide (EPG) key word extractor 221 and a broadcasting key frame extractor 222. The video search engine 210 includes a streaming video crawler 211, a streaming video key word extractor 212 and a streaming video index generator 213. The social media search engine 230 includes a social media crawler 231, a social media key word extractor 232 and a social media index generator 233.

In some embodiments, the streaming video crawler 221 may crawl video key words from Internet video library 400 beforehand, and the streaming video key word extractor 212 extracts the key words of the streaming video from the crawled information, indices are generated by the streaming video index generator 213 to be used for subsequent matching search. Similarly, the social media crawler 231 included in the social media search engine 230 of the server 200 may crawl contents about video programs on a public social media beforehand, and the social media key word extractor 232 extracts key words, thereby generating indices by the social media index generator to be used for subsequent matching search.

As shown in FIG. 2, a broadcasting EPG key word extractor 221 parses the electronic program guide of a certain video program to extract key words. A broadcasting key frame extractor 222 extracts key frames from the video programs, for example, extracting image frames representative of the main contents of the video shots from the video programs as the key frames. The broadcasting key frame extractor 222 recognizes the extracted key frames to obtain the recognized text contents, and combines at least part of the recognized text contents and the key words and using the combined as the key information. For example, the broadcasting key frame extractor 222 recognizes text contents in the extracted key frames by using text recognition technology and/or weighting at least part of the recognized text contents and the key words followed by sequencing them to generate the key information. In this way, a search manager 220 may search for contents related with the key information on a public social media by using the key information, obtain search results, extract an abstract from the search results as an inquiry request, and search for video programs in a broadcasting video library and an Internet video library based on the inquiry request, and use the obtained search results as a video program recommendation for the particular video program.

In some embodiments, a streaming video crawler 211 crawls key words of a streaming video from a broadcasting video library 300 and/or Internet video library 400, and then a streaming video key word extractor 212 extracts a streaming video key word abstract, and then a streaming video index generator 213 generates streaming video indices by scoring these key words. Similarly, a public social media crawler 232 crawls key words from a public social media, and a social media key word extractor 232 generates public social media key words, and then a public social media index generator 233 generates public social media indices by scoring the public social media. The search engine firstly matches the key information with the indices generated by the social media index generator in a data interaction unit 240 to search for initial results, and then the results are extracted to generate a further search query, and this search query and streaming video indices are used to perform matching search to obtain video program search results. Thereafter, a server 200 stores the video program recommendations in association with the video programs, and when a user requests for playing the video programs, a terminal 100 provides corresponding video program recommendations, and then a browser/App 120 presents the video program recommendations to the user in association with the programs to be played.

According to some embodiments, a preview of the video recommendations is played in response to a user's selection for the video program recommendations in a manner that does not affect the currently played video programs. In other embodiments, in order to count the click through rate of the video program recommendations, the terminal 100 also counts the click through rate of the video program recommendations by the user as auxiliary rating information, and sends the auxiliary rating information to the server 200.

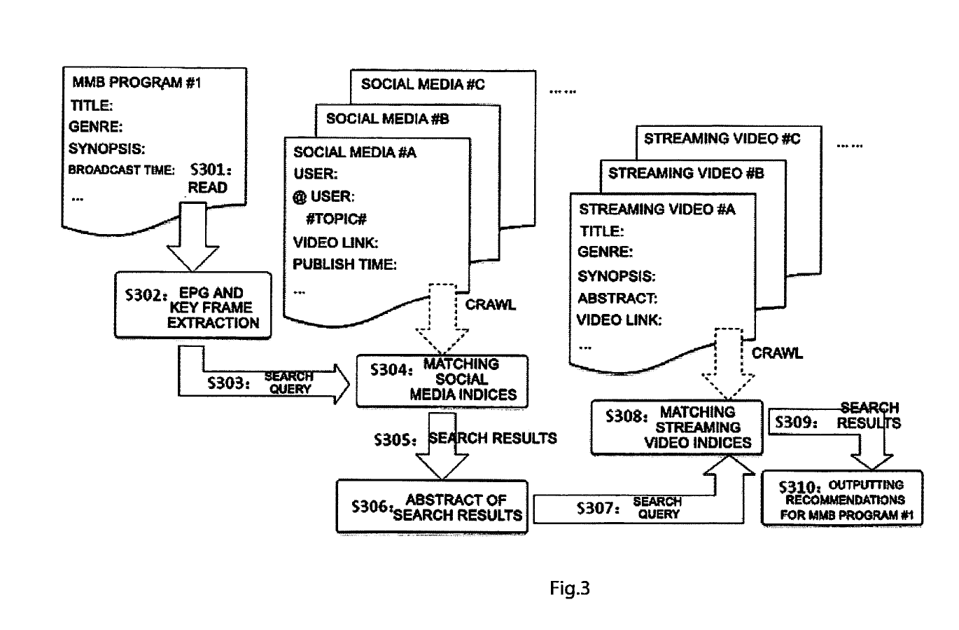

FIG. 3 illustrates an interaction process of a mobile Internet terminal and a server according to an embodiment of the present disclosure.

As shown in FIG. 3, in step S301, a server reads video programs from a broadcasting video path, and lists the read broadcasting program #1, and the broadcasting program has metadata such as title, genre, synopsis, broadcast time, etc.

In step S302, key information is extracted from the electronic program guide of the video program and the video program.

In step S303, a search query is generated based on the key information.

In step S304, the search query and the social media indices generated previously are used to implement matching search, and a search result is generated in step S305.

Key words are extracted from the search result in step S306, and a new search query is generated in step S307. The new search query and the streaming video indices are used for matching search in step S308, and a search result is generated in step S309.

Then, in step S310, the server 200 stores the obtained video program recommendations in association with the video programs, and provides the video program recommendations to the mobile terminal when a user plays the video programs.

Although some of the embodiments of the present disclosure are described in the above embodiments in connection with the process of interaction between a terminal 100 and a server 200, a person having ordinary skill in the art may implement the present invention at the mobile terminal 100 or the server 200.

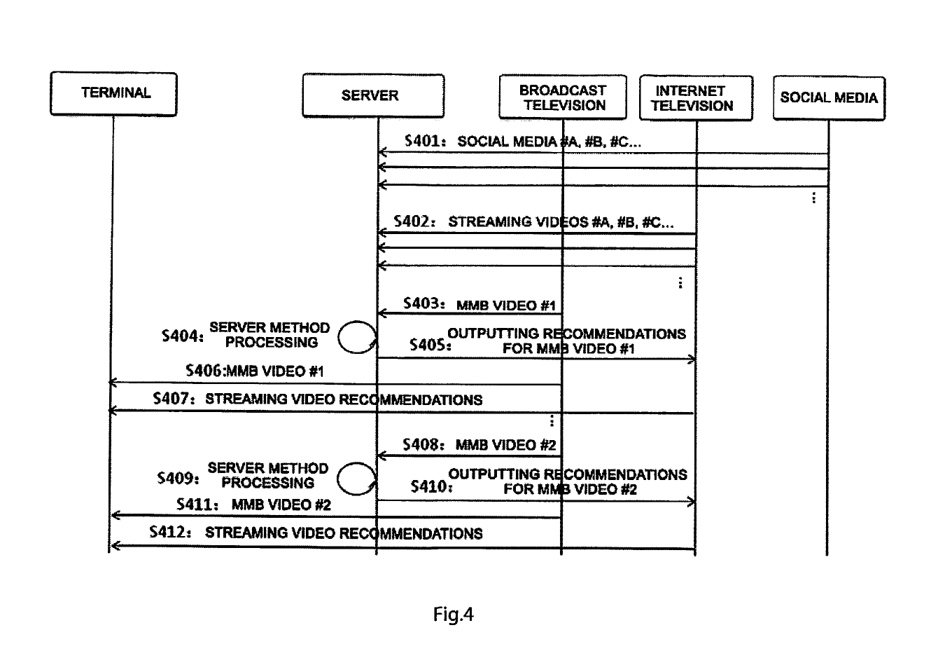

FIG. 4 is a flow chart of a recommendation method according to an embodiment of the present disclosure. As shown in FIG. 4, in step S401, a server 200 crawls contents of a social media to generate social media indices. In step S402, the server 200 crawls Internet video programs to generate streaming video indices. Thereafter, in step S403, the server 200 reads a broadcasting program, for example MMB program #1, implements the above method processing of generating video recommendations at the server, and outputs video recommendations for the broadcasting program in step S405. In step S406, the mobile terminal 100 receives the broadcasting program #1, and the server delivers the video program recommendations previously generated and stored at the terminal to be presented to the user in step S407.

Similarly, in step S408, as for a broadcast video program #2, the server 200 reads the contents of the program, and implements the above method process of generating video recommendations in step S409, and outputs the video recommendations in step S410. In step S411, a mobile terminal 100 receives the broadcasting program #2, and the server delivers the video program recommendations previously generated and stored at the terminal to be presented to the user in step S412.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Although the present invention is described with reference to several typical embodiments, it should be appreciated that the terms used are descriptive and illustrative, rather than limiting terms. Since the present invention may be specifically implemented in many forms without departing the spirit or essence of the invention, it shall be appreciated that the above embodiments are not limited to any aforesaid detail, but should be widely construed in the spirit and scope defined in the attached claims. Therefore, all changes and transformations falling into the scope of the claims or equivalent scope thereof shall be covered by the attached claims.

What is claimed is:

1. A method for generating a video program recommendation for a particular video program, the method comprising the following steps of:
extracting key information from an electronic program guide (EPG) of the particular video program and the particular video program;
searching for contents related with the key information on a public social media by using the key information, and obtaining search results;
extracting an abstract from the search results as an inquiry request;
searching for video programs in a broadcasting video library and an Internet video library based on the inquiry request, and using obtained search results as the video program recommendation for the particular video program; and
storing the video program recommendation in association with the particular video program.

2. The method according to claim 1, further comprising a step of:
sending the video program recommendation to a user when the user requests for the particular video program.

3. The method according to claim 1, wherein the step of extracting key information from an electronic program guide of the particular video program and the particular video program comprises:
parsing the electronic program guide to extract key words;
extracting key frames from the particular video program;
recognizing the extracted key frames to obtain recognized text contents; and
combining at least part of the recognized text contents and the key words, using the combined as the key information.

4. The method according to claim 3, wherein the step of extracting key frames from the particular video program comprises:
extracting image frames representative of main contents of video shots from the particular video program as the key frames.

5. The method according to claim 3, wherein the step of recognizing the extracted key frames comprises:
recognizing text contents in the extracted key frames by using text recognition technology.

6. The method according to claim 3, wherein the step of combining at least part of the recognized text contents and the key words comprises:
weighting at least part of the recognized text contents and the key words followed by sequencing them to generate the key information.

7. The method according to claim 1, wherein the step of extracting an abstract from the search results comprises:
scoring each of the search results; and
extracting key words from search results whose scores are higher than a predetermined value to generate the abstract.

8. The method according to claim 1, wherein the step of searching for contents related with the key information on a public social media by using the key information comprises:
crawling contents on the public social media to generate public social media indices;
matching the key information with the public social media indices; and
taking contents corresponding to the public social media indices whose matching degrees are higher than a predetermine threshold as the search results.

9. The method according to claim 1, wherein the step of searching for video programs in a broadcasting video library and an Internet video library based on the inquiry request comprises:
crawling the broadcasting video library and Internet video library to generate streaming video program indices;
matching the inquiry request with the streaming video program indices; and
taking contents corresponding to the streaming video program indices whose matching degrees are higher than a predetermine threshold as the search results.

10. A server for generating a video program recommendation for a particular video program, comprising:
an extractor for extracting key information from an electronic program guide of the particular video program and the particular video program;
a search engine for searching for contents related with the key information on a public social media by using the key information, obtaining search results, extracting an abstract from the search results as an inquiry request, and searching for video programs in a broadcasting video library and an Internet video library based on the inquiry request, and using obtained search results as the video program recommendation for the particular video program; and
a storage for storing the video program recommendation in association with the particular video program.
